(19) United States
(12) Patent Application Publication
(10) Pub. No.: US 2008/0046345 A1
(43) Pub. Date: Feb. 21, 2008

(54) Method of managing products disposed on an intelligent display rack and corresponding intelligent display rack

(75) Inventor: Frederic Serre, Eybens (FR)

Correspondence Address: Ralph A. Dowell of DOWELL & DOWELL P.C., 2111 Eisenhower Ave, Suite 406, Alexandria, VA, 22314, US

(73) Assignee: SUPERTEC, Echirolles (FR)

(21) Appl. No.: 11/585,921

(22) Filed: Oct. 25, 2006

Related U.S. Application Data
(60) Provisional application No. 60/844,654, filed on Sep. 15, 2006.

(30) Foreign Application Priority Data
Aug. 17, 2006 (FR) 06 07353

(51) Int. Cl. G06Q 10/00; A47G 25/06

(52) U.S. Cl. 705/28; 211/1

(57) ABSTRACT

The display rack comprises a screen, connected to a control circuit, supports for products, furnished with RFID tags, and at least one radiofrequency antenna connected to the control circuit. When a product is removed from the display rack, a multimedia message corresponding to this product is broadcast. When a manager introduces an administration tag, of RFID type, into a zone covered by the antenna, its presence is detected and an administration interface displayed. This interface indicates a type of new product to be placed on the display rack. The identification code of the tag of a new product introduced onto the display rack is automatically detected and associated with the type of product considered. The control circuit can, moreover, cause the broadcasting of a comparative between two products when the latter are removed from the display rack in less than 20 s. A presence detector can allow the broadcasting of appropriate messages upon the approach of a customer.

### TECHNICAL FIELD OF THE INVENTION

The invention relates to a method of managing products, each furnished with an individual tag of RFID type together with a corresponding identification code and disposed on an intelligent display rack comprising a display screen, connected to a control circuit, means of support of the products and at least one radiofrequency transmit/receive antenna connected to the control circuit, the control circuit causing the displaying on the screen of information representative of a product when said product is removed from the display rack.

It also relates to an intelligent display rack for the implementation of such a method.

### PRIOR ART

The generalization of the use of intelligent tags, of RFID type together with a corresponding identification code, has made it possible to enhance the information available for the management of products, in particular in commercial businesses. Moreover, patent application JP-A-2005-010608 describes a display rack, associated with a display screen, which makes it possible to detect the removal of a product from the display rack, when a customer picks this product up to examine it more closely, and to display on the screen a commercial message associated with this product.

As illustrated diagrammatically in FIG. 1, such a display rack comprises an electronic control circuit 1, furnished with a radiofrequency transmit/receive antenna 3 and connected to a display screen 2. When a product, furnished with an RFID tag 4, is disposed on the display rack, the control circuit 1 detects its presence in a zone covered by radiofrequency electromagnetic radiation emitted by its antenna 3. The tag 4 may be a passive tag. In a know manner, a carrier signal received by the RFID tag 4 may serve simultaneously as signal of interrogation and energy supply of the tag. The latter then returns a carrier signal, amplitude modulated by its individual identification code. When the control circuit detects the disappearance of a tag from the observed zone, it considers that the corresponding product has been picked up by a customer and displays on the screen 2 a commercial message associated with this product.

### SUBJECT OF THE INVENTION

The aim of the invention is to improve the management of products disposed on an intelligent display rack.

This aim is achieved by the fact that, a manager having introduced an administration tag, of RFID type, into a zone covered by the transmit/receive antenna, the control circuit detects the presence of the administration tag and commands the displaying of an administration interface on the screen and wherein, said administration interface indicating a type of new product to be placed on the display rack, the control circuit detects the identification code of the tag of a new product introduced onto the display rack and associates the identification code of the new product with the type of product considered.

According to a development of the invention, the control circuit determines the time elapsed between the successive removal of two products from the display rack and causes the broadcasting of a comparative between the two products if said time elapsed is less than or equal to a predetermined threshold, which may be of the order of 20 s.

According to another development of the invention, the display rack comprising a presence detection device connected to the control circuit, the control circuit causes the broadcasting of a message associated with the products disposed on the display rack when it detects the presence of a person in proximity to the display rack. By virtue of the combination of several detectors, the message broadcast may take account of the precise position of the person in front of the display rack.

A display rack for the implementation of a method according to the invention comprises a display screen, connected to a control circuit, means of support of products, each furnished with an individual tag of RFID type, with a corresponding identification code, at least one radiofrequency transmit/receive antenna connected to the control circuit, the control circuit comprising means of detection of the removal of a product from the display rack and means for causing the displaying on the screen of data representative of said product upon its removal from the display rack. The display rack is characterized in that the control circuit comprises means of recognition of an administration tag, of RFID type, means for displaying on the screen, in response to this detection, an administration interface indicating the type of new product to be placed on the display rack and means for associating said type of product and the identification code of the tag of a new product placed on the display rack after displaying of the administration interface.

### BRIEF DESCRIPTION OF THE DRAWINGS

Other advantages and characteristics will emerge more clearly from the description which follows of particular embodiments of the invention given by way of nonlimiting examples and represented in the appended drawings in which:

FIG. 1 illustrates, in block diagram form, the interaction between the control circuit and the RFID tag of a product disposed on an intelligent display rack according to the prior art.

FIG. 2 diagrammatically represents a particular embodiment of an intelligent display rack according to the invention.

FIGS. 3 to 5 illustrate, in the form of flow charts, a particular embodiment of a method of management according to the invention.

FIG. 6 illustrates a display rack making it possible to detect a person in proximity to the display rack.

FIG. 7 represents, in flow chart form, a particular mode of use of the display rack according to FIG. 6.

FIGS. 8 to 10 illustrate various alternative dispositions of the antennas of a display rack according to the invention.

### DESCRIPTION OF PARTICULAR EMBODIMENTS

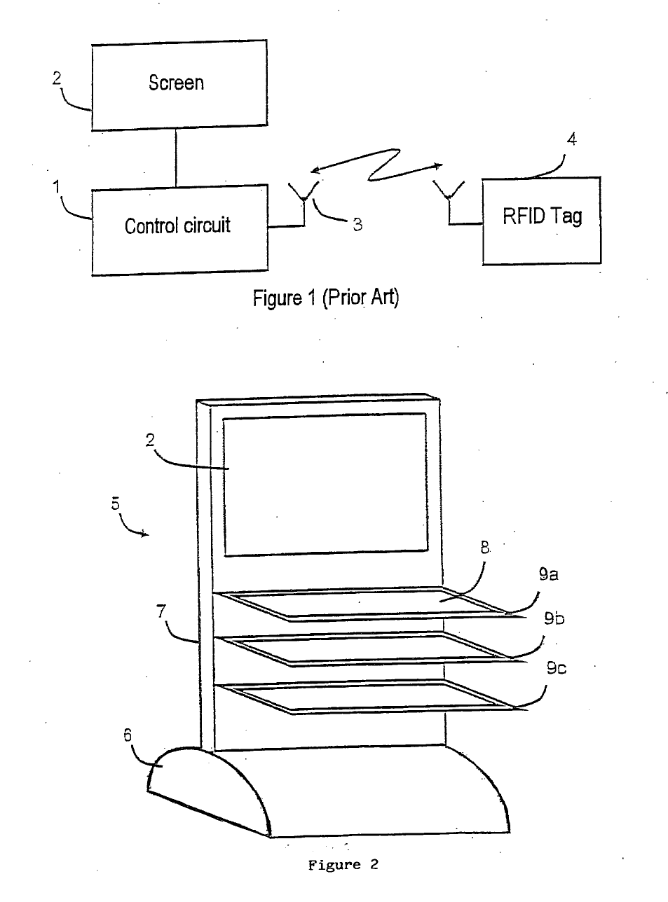

The display rack 5 illustrated in FIG. 2 comprises a stand 6, to which is fixed a vertical, rear wall 7. The display screen 2 is disposed at the upper part of the rear wall. In the example illustrated in FIG. 2, the display rack comprises three shelves 8, superposed, intended to serve as support for products (not represented), each furnished with an individual tag 4, of RFID type having an identification code assigned to the product. The tags 4 are, preferably, standard passive tags. However, the term tag of RFID type encompasses any type of RFID transponder apt to be used to identify a product, that is to say either in the form of an actual tag, self-adhesive or otherwise, or in the form of a card, token or insert, etc.

The shelves may be replaced or supplemented with any other type of support. Support rods may, for example, be fixed perpendicularly to the rear wall 7 of the display rack 5 and disposed in such a way as to form several adjacent columns. Likewise, hanger support rails may be fixed parallel to the rear wall.

The display rack comprises at least one transmit/receive antenna. In the example of FIG. 2, three antennas 9a, 9b and 9c, parallel, are respectively associated with each of the shelves 8. Each of the antennas surrounds one of the shelves, so as to cover a zone encompassing at least the totality of the products disposed on the shelf. The three antennas may, for example, be controlled by the control circuit 1, for example microprocessor based, integrated into the display rack or situated remotely, by way of a r/demultiplexer circuit (not represented), successively activating the antennas. Thus, the activation of the antenna 9a allows the reading of the RFID tags 4 of all the products disposed on the corresponding shelf. The subsequent activation of the antenna 9b, then of the antenna 9c, allows the control circuit to rapidly avail itself of the identification codes of the RFID tags of all the products disposed on the display rack 5. The multiplexing of the antennas, at least in read mode, makes it possible to avoid disturbances.

To facilitate the management of the products disposed on the display rack, the manager avails himself of an administration card furnished with a specific administration tag, also of RFID type. Such a tag is read, at the same time as the tags of the product, during the activation of the antennas and may be distinguished from the product tags by the control circuit.

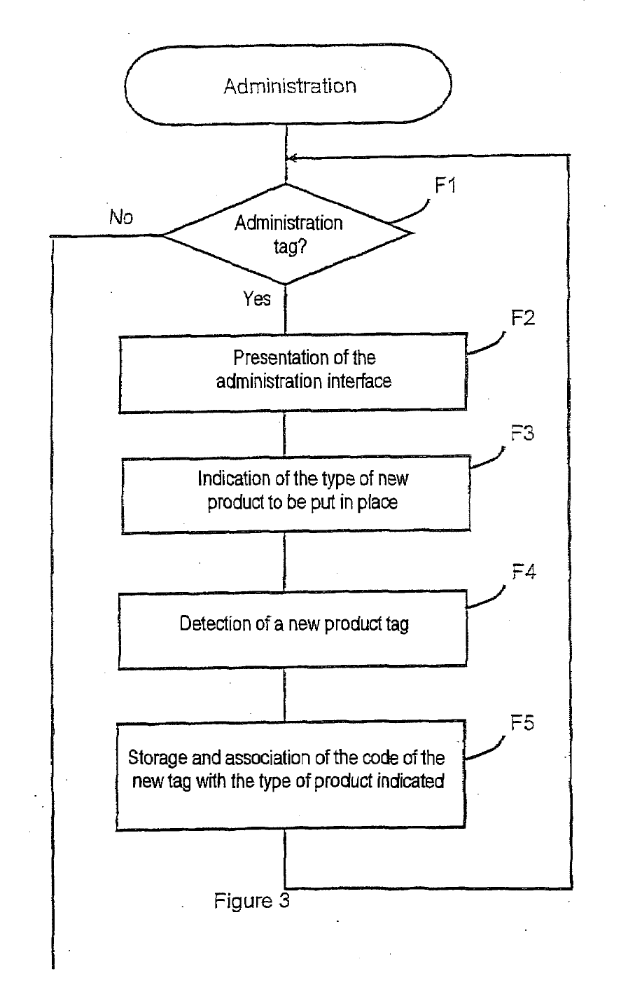

In the example illustrated in FIG. 3, in an administration subprogram, the control circuit 1 checks, in a step F1, to verify whether an administration tag is disposed on the display rack or in proximity, in the zone covered by the antennas. If such is the case (Yes output of F1), the control circuit 1 presents, in a step F2, an administration interface on the display screen 2 of the display rack. Indications on the course to be followed are then broadcast. The messages broadcast may possibly be of multimedia type. In this case, a loudspeaker (not represented) is preferably associated with the screen. This broadcast comprises in particular (step F3) indications on the type of new product to be placed on the display rack, for example within the framework of management instructions previously defined and sent, by any appropriate means, to the control circuit. The manager follows these indications and places new products of this type on the display rack. When a new product is placed on the display rack, its RFID tag is detected by the control circuit, in a step F4. Said circuit stores and then associates the identification code of the tag of the new product with the type of product previously indicated.

The control circuit has thus automatically recorded the code of the RFID tag of the new product and has automatically associated it with the corresponding product type. It will thus be able, subsequently, to broadcast corresponding multimedia messages when this product is picked up by a customer. The control circuit of the display rack is thus programmed automatically as a function of the products actually placed on the display rack.

Steps F1 to F5 may be repeated for as long as the administration tag remains on the display rack or in proximity. When the manager has finished, he removes his administration card and the control circuit finishes the administration phase when it no longer detects the presence of the administration tag (No output of F1).

Such an administration phase is, for example, performed after each reading of all the tags covered by the antennas of the display rack. This phase is interrupted immediately after step F1 in the absence of the administration card.

It is thus possible to allow an interaction between the manager and the control circuit of the display rack 5, without requiring the presence of peripherals, of the keyboard, mouse, etc. type.

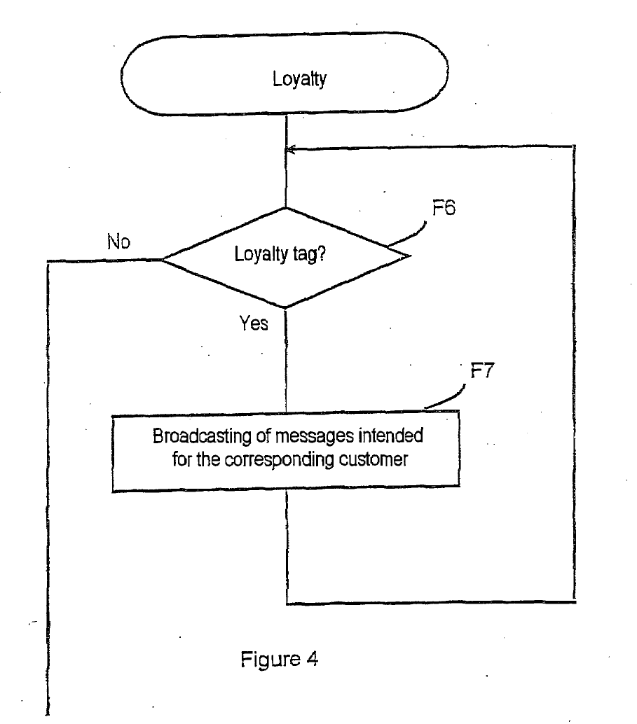

In a similar manner, the control circuit can detect the presence of a loyalty card of a customer using a loyalty subprogram, illustrated in FIG. 4. Each loyalty card being furnished with a loyalty tag of RFID type, its presence on the display rack or in proximity thereto may be detected by the control circuit as soon as the loyalty card enters the zone covered by the antennas. The control circuit 1 checks, in a step F6, to verify whether a loyalty tag is disposed on the display rack or in proximity, in the zone covered by the antennas. If such is the case (Yes output of F6), the control circuit 1 broadcasts on the display screen 2 of the display rack, in a step F7, messages, for example in multimedia form, intended for the customer. Messages of this type may, for example, consist in greeting the customer with his name, in offering him a reduction on certain of the products disposed on the display rack, etc.

Like the administration subprogram, the loyalty subprogram may be performed after each reading of all the tags covered by the antennas of the display rack. This subprogram is interrupted immediately after step F6 in the absence of a loyalty card.

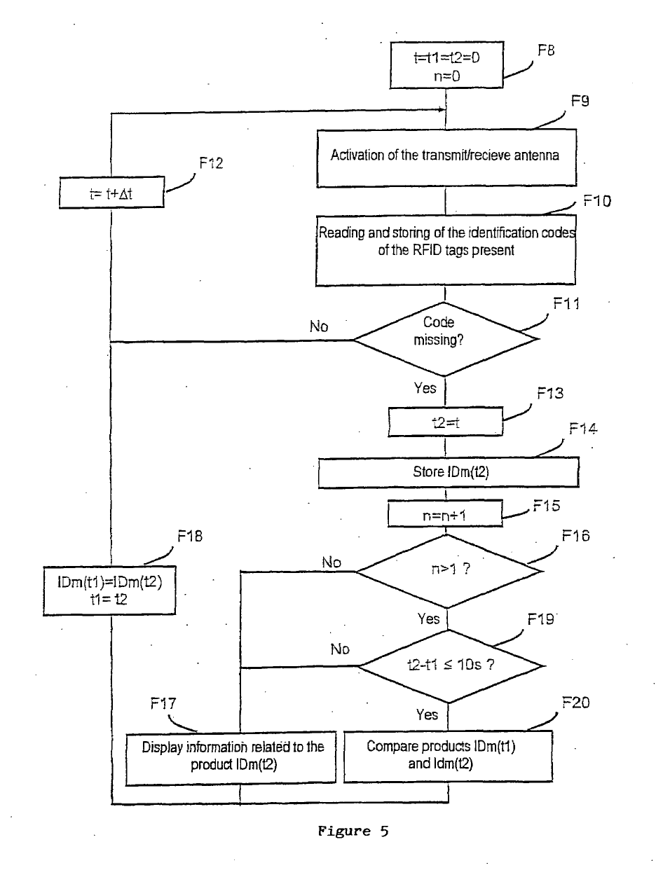

The flow chart of FIG. 5 illustrates an exemplary embodiment of a management program implemented by the control circuit 1.

In an initialization step F8, quantities t, t1, t2 and n, whose meaning will be explained hereinbelow, are set to zero (t=t1=t2=0 and n=0). Next, in a step F9, the control circuit activates the transmit/receive antenna or antennas of the display rack (5). Thereafter (step F10), it reads and stores the identification codes of all the RFID tags present. The administration and loyalty subprograms are, preferably, activated after this step F10.

The control circuit thereafter checks, in a step F11, to verify whether an identification code of a product, previously disposed on the display rack is missing. For this purpose it compares the list of the identification codes of products detected in step F10 with a previously recorded list. If no product has been removed from the display rack (No output of F11), the two lists are identical and the control circuit returns to step F9 to activate the antennas, after having, in a step F12, incremented the quantity t, representative of the time elapsed since the initialization phase (t=t+Δt).

On the other hand, if an identification code is missing (Yes output of F11), the control circuit stores, in a step F13, the instant t2 corresponding to the removal of the product (t2=t) and, in a step F14, the identification code IDm(t2) missing at this instant. The control circuit then increments, in a step F15, the number n, which is representative of the number of products successively removed from the display rack: n=n+1. It thereafter checks (step F16: n>1?) to verify whether this is the first product removed since the initialization step F8. If such is the case (No output of F16), the control circuit will search an appropriate database for the characteristics of the product and displays on the screen or broadcasts, in a step F17, information related to the product whose code IDm(t2) is no longer detected. This information may be in any appropriate form, for example in the form of a slip summarizing the characteristics and advantages of the product, or in the form of a multimedia content referring to the product.

Thereafter the control circuit returns to step F12, to increment the time t and then to step F9 to activate the antennas, after having, in a step F18, stored in memory the value t2, as old quantity t1 and the code IDm(t2) as old quantity IDm(t1):t1=t2 and IDm(t1)=IDm(t2).

If n>1, that is to say if the product removed from the display rack is not the first since the initialization step (Yes output of F16), the control circuit compares the time t2−t1 elapsed since the previous removal with a predetermined threshold. In the example represented in FIG. 5, the threshold chosen is 10 s:t2−t1<10 s? If the time t2−t1 elapsed since the previous removal is greater than this threshold (No output of F19), the control circuit goes, as previously, to step F17 and displays or broadcasts information corresponding to the last product picked up by a customer. On the other hand, if the time elapsed since the previous removal is less than or equal to the chosen threshold (Yes output of F19), the control circuit broadcasts, in a step F20, a comparative between the two products, whose identification codes have respectively been stored as IDm(t2) for the last one and as IDm(t1) for the previous one. After step F20, the control circuit goes to step F18.

Thus, when a customer grasps a product disposed on the display rack, the control circuit 1 detects the modification of the list of RFID tags present and can, through the difference, determine which product is the one grasped. The screen 2 then automatically broadcasts, in particular on the screen, a multimedia content corresponding to this product. If the customer grasps a second product disposed on the display rack, without necessarily putting back the previous one, it is considered that he is vacillating between the two products and if they can be compared, the display rack then broadcasts a comparative of the two products to help him in his choice.

The lag t2−t1 causing the broadcasting of a comparative is less than or equal to 20 s, preferably less than or equal to 10 s.

The display rack is, preferably, supplemented with a presence detection device, for example of infrared type, intended to detect the approach of a person so as to broadcast, in particular on the screen, appropriate contents as a function of the position of this person in relation to the display rack.

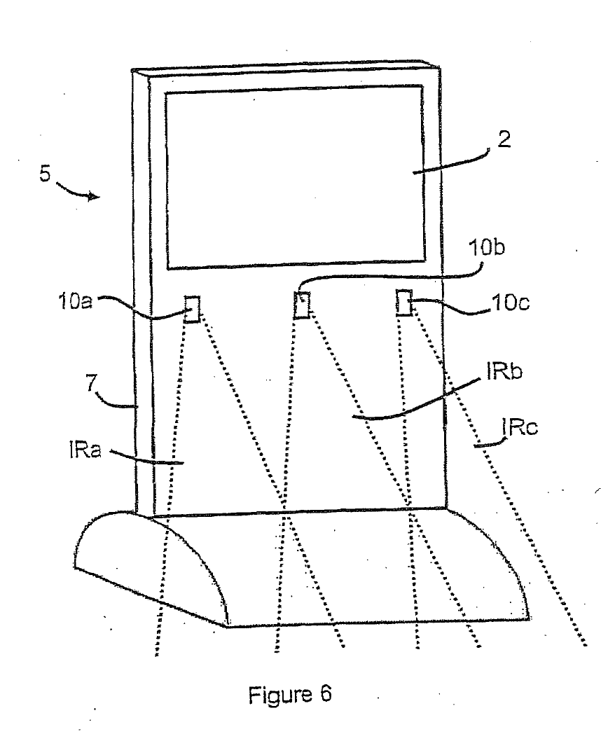

In the particular embodiment illustrated in FIG. 6, the presence detection device comprises on its rear wall 7 three presence detectors, respectively 10a, 10b and 10c. The supports of the products and the antennas are omitted in FIG. 6 for reasons of clarity. Each presence detector comprises an infrared transmitter, transmitting a divergent infrared beam, respectively IRa, IRb and IRc. Such a device is more particularly adapted in the case where the products are disposed in adjacent columns on the display rack in particular in the case where the supports consist of columns of rods intended for different type products. By way of example, electric batteries of a first type may be disposed in a first column, on the left in FIG. 6, batteries of a second type in a second column, central, and lamps in the third column, on the right.

The presence detectors make it possible to more precisely determine the position of the person in relation to the display rack and to broadcast the most appropriate messages. Thus, when the person begins to approach, they are firstly in the three beams IRa, IRb and IRc and their presence is detected by the three detectors. The message broadcast remains general, associated with the whole set of products (batteries and lamps in the example considered) disposed on the display racks. When approaching, for example on the left of the display rack, they are thereafter situated only in the beams IRa and IRb, and the message broadcast is associated with the types of products of the two corresponding adjacent columns. In the example considered, the message broadcast relates now to batteries only. Next, the person continuing to approach and heading towards the products in which they are most interested, is now situated only in one of the infrared beams, for example in the beam IRa, and the message broadcast relates more particularly to the products of the corresponding column, the batteries of the first type in the example considered.

The angle of each divergent infrared beam is, preferably, between 1° and 120°.

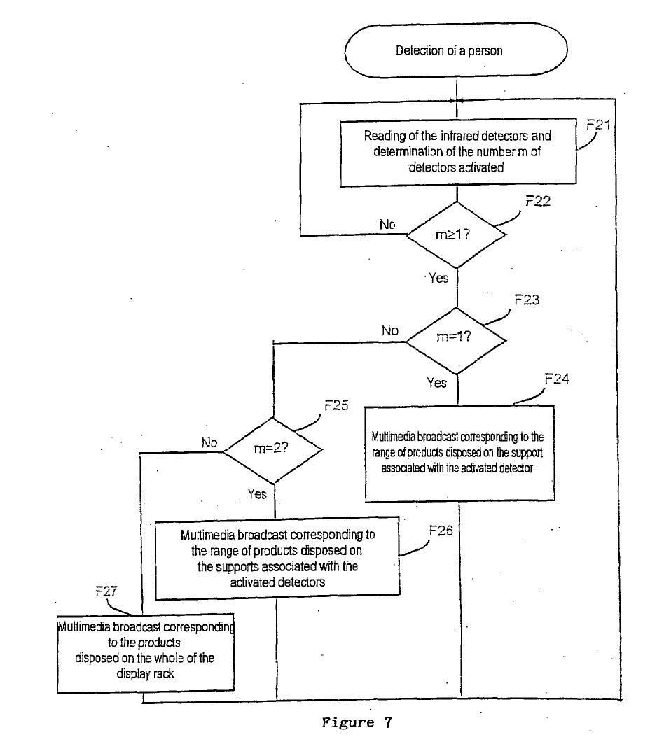

In the subprogram illustrated, by way of example, in FIG. 7, the control circuit 1 performs, in a step F21, the reading of the infrared detectors and determines the number m of activated detectors. Next, in a step F22, it checks to verify whether at least one detector is activated (m≧1?). If such is not the case (No output of F22), it returns to phase F21. If at least one of the detectors is activated (Yes output of F22), the control circuit checks, in a step F23, to verify whether a single detector is activated (m=1?). If such is the case (Yes output of F23), the control circuit determines which column is the closest and causes (step F24) the broadcasting of a message, preferably multimedia, corresponding to the range of products disposed on the support associated with the activated detector or, more generally with the type of products disposed in the column corresponding to this detector. On the other hand, if more than one detector is activated (No output of F23), it checks in a step F25 to verify whether only two detectors are activated (m=2?). If such is the case (Yes output of F25), the multimedia message broadcast (step F26) corresponds to the range of products disposed on the supports associated with the two activated detectors or, more generally, with the types of products of the two corresponding adjacent columns. If more than two detectors are activated (No output of F25), this signifies, in the example represented, that all the detectors are activated and that a person is approaching the display rack. The control circuit 1 then causes (step F27) a multimedia broadcast corresponding to the whole set of products disposed on the whole of the display rack.

The control circuit can, moreover, automatically place in memory the succession of products picked up by customers. The log thus placed in memory can be used to automatically compile statistics relating to the behavior of customers, the display rack thus fulfilling a function of learning of consumer habits. These statistics may then be used by the control circuit to adapt, accordingly, the content, the duration and/or the succession of subsequent multimedia broadcasts.

In order for the operation of the intelligent display rack not to depend on the position of the products on the display rack, the number, the shape and the disposition of the antennas are chosen in such a way that the electromagnetic radiating lobe or lobes emitted by the transmit/receive antennas approximates as closely as possible the shape of the display rack, so as to cover the totality of the products that may be disposed on the display rack 5.

Thus, in the example illustrated in FIG. 2, three parallel antennas, 9a, 9b and 9c, superposed, are respectively disposed around three superposed shelves 8 and each antenna covers a transmit/receive zone enveloping the products disposed on the corresponding shelf. Three antennas may, as described hereinabove, be activated successively by switching by means of a multiplexer/demultiplexer. As a variant, just one of the antennas, preferably the central antenna 9b, may be linked to the control circuit, the other antennas, 9a and 9b, being coupled automatically to the antenna 9b by induction. The three antennas are then activated simultaneously, by vertical coupling of the antennas, upon the activation of the central antenna.

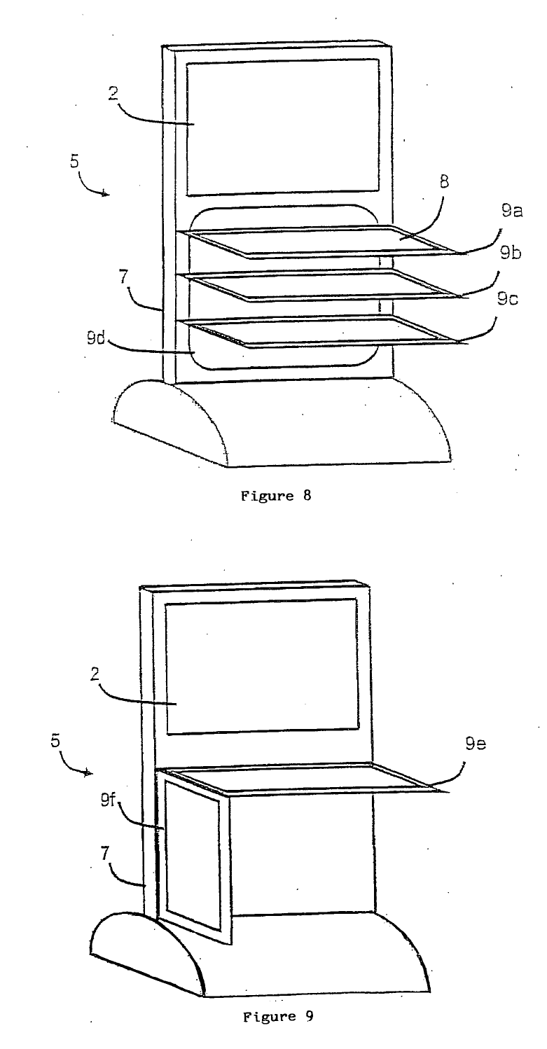

In the multiplane variant embodiment illustrated in FIG. 8, the antennas are disposed in two perpendicular planes. Just one transmit/receive antenna 9d, disposed on the rear wall 7 of the display rack, at the level of the shelves 8, is connected to the control circuit 1. Additional antennas 9a, 9b and 9c, perpendicular to the antenna 9d and, as previously associated with each shelf, are coupled to the antenna 9d by induction. The activation of the antenna 9d thus causes the emission of a multiplane radiation covering the whole of the display rack and allowing the detection of all the products, irrespective of their position on the display rack.

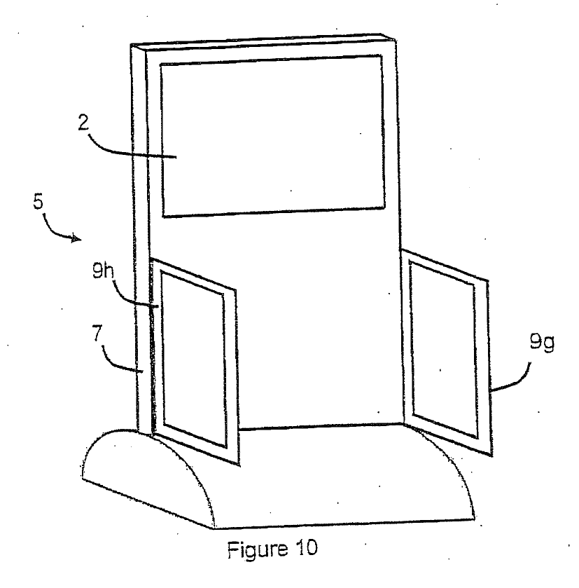

In the variant embodiments illustrated in FIGS. 9 and 10, the supports are not represented for reasons of clarity. In the 3D multi-antenna variant of FIG. 9, two perpendicular antennas 9e and 9f are disposed beneath the screen respectively horizontally and vertically on a lateral side of the display rack. Each antenna covers the totality of the zone in which the products may be disposed but their perpendicular orientations ensure reading of the tags in all positions. The two antennas 9e and 9f are, preferably, activated sequentially by the control circuit 1. In the door-like variant of FIG. 10, two antennas 9h and 9g are disposed vertically, on either side of the display rack, more precisely on either side of the zone of support of the products, beneath the screen 2. One of the antennas is then, preferably, a transmit/receive antenna, while the other is only a receive antenna, so as to limit disturbances.

In a preferential embodiment, the antennas 9 emit at a frequency of 13.56 MHz.

1. A method of managing products, each furnished with an individual tag of RFID type together with a corresponding identification code and disposed on an intelligent display rack comprising a display screen, connected to a control circuit, means of support of the products and at least one radiofrequency transmit/receive antenna connected to the control circuit, the control circuit causing the displaying on the screen of information representative of a product when said product is removed from the display rack, method wherein, a manager having introduced an administration tag, of RFID type, into a zone covered by the transmit/receive antenna, the control circuit detects the presence of the administration tag and commands the displaying of an administration interface on the screen and wherein, said administration interface indicating a type of new product to be placed on the display rack, the control circuit detects the identification code of the tag of a new product introduced onto the display rack and associates the identification code of the new product with the type of product considered.

2. The method as claimed in claim 1, wherein the control circuit detects the presence of a customer loyalty card, furnished with an RFID tag, and causes the broadcasting of messages intended personally for said customer.

3. The method as claimed in claim 1, wherein the control circuit determines the time elapsed between the successive removal of two products from the display rack and causes the broadcasting of a comparative between the two products if said time elapsed is less than or equal to a predetermined threshold.

4. The method as claimed in claim 3, wherein said threshold is 20 s.

5. The method as claimed in claim 1, wherein, the display rack comprising a presence detection device connected to the control circuit, the control circuit causes the broadcasting of a message associated with the products disposed on the display rack when it detects the presence of a person in proximity to the display rack.

6. The method as claimed in claim 5, wherein the presence detection device comprising a plurality of presence detectors, respectively associated with a plurality of adjacent columns, the control circuit detecting the presence of a person in proximity to the display rack determines the column closest to said person and causes the broadcasting of a message associated with the type of products disposed in said column.

7. The method as claimed in claim 6, wherein each presence detector comprising a transmitter transmitting a divergent infrared beam, the detection of the presence of a person in two adjacent beams causes the broadcasting of a message associated with the type of products of the two corresponding adjacent columns.

8. The method as claimed in claim 7, wherein each divergent infrared beam has an angle of between 1° and 120°.

9. An intelligent display rack for the implementation of a method as claimed in claim 1, comprising a display screen, connected to a control circuit, means of support of products, each furnished with an individual tag of RFID type, with a corresponding identification code, at least one radiofrequency transmit/receive antenna connected to the control circuit, the control circuit comprising means of detection of the removal of a product from the display rack and means for causing the displaying on the screen of data representative of said product upon its removal from the display rack, wherein the control circuit comprises means of recognition of an administration tag, of RFID type, means for displaying on the screen, in response to this detection, an administration interface indicating the type of new product to be placed on the display rack and means for associating said type of product and the identification code of the tag of a new product placed on the display rack after displaying of the administration interface.

10. The display rack as claimed in claim 9, wherein the control circuit comprises means for placing in memory the set of identification codes of the RFID tags of the products deposited on the display rack and wherein the means of detection of the removal of a product from the display rack comprise means of comparison of said set at two successive instants.

11. The display rack as claimed in claim 9, wherein the control circuit comprises means of determination of the time elapsed between the detection of the successive removal of two products and means for broadcasting a comparative between the two products if said time elapsed is less than or equal to a predetermined threshold.

12. The display rack as claimed in claim 9, wherein it comprises presence detectors, consisting of divergent infrared detectors, respectively associated with a plurality of supports forming adjacent columns.

13. The display rack as claimed in claim 9, wherein it comprises means of storage of the succession of products picked up by customers.

14. The display rack as claimed in claim 9, wherein it comprises two antennas, respectively receive and transmit/receive, disposed vertically either side of the display rack.

15. The display rack as claimed in claim 9, wherein it comprises two perpendicular transmit/receive antennas.

16. The display rack as claimed in claim 9, wherein it comprises additional antennas, perpendicular to said transmit/receive antenna and connected to said transmit/receive antenna by induction.

17. The display rack as claimed in claim 9, wherein it comprises a plurality of parallel antennas.

18. The display rack as claimed in claim 17, wherein each antenna is associated with a predetermined transmit/receive zone, enveloping the products disposed on at least one predetermined support of the display rack.

19. The display rack as claimed in claim 18, wherein the control circuit comprises means of successive activation of the various antennas.

20. The display rack as claimed in claim 19, wherein the control circuit is connected to a single antenna, connected by induction to the other antennas.

21. The display rack as claimed in claim 9, wherein the supports consist of shelves, support rods and/or hanger support rails.
